(19) United States
(12) Patent Application Publication
(10) Pub. No.: US 2009/0016713 A1
(43) Pub. Date: Jan. 15, 2009

(54) METHOD, APPARATUS, SYSTEM, AND COMPUTER PROGRAM TO DEBUG AN OPTICAL NETWORK TERMINAL USING DIAGNOSTIC OPTICAL NETWORK TERMINAL

(75) Inventors: David H. Liu, Herndon, VA (US); Guy M. Merritt, Purcellville, VA (US); Brendan Mannix, Fairfax, VA (US)

Correspondence Address: FITZPATRICK CELLA (TELLABS), 30 ROCKEFELLER PLAZA, NEW YORK, NY, 10112-3800, US

(73) Assignee: Tellabs Vienna Inc., Naperville, IL (US)

(21) Appl. No.: 11/777,817

(22) Filed: Jul. 13, 2007

(51) Int. Cl. H04B 10/08

(52) U.S. Cl. 398/17

(57) ABSTRACT

A method of detecting a problem in a communication network that supports at least one communication service communication service is provided. The method includes disconnecting a suspect component from the network, and replacing the suspect component with a diagnostic component configured to have the same network identification information as the suspect component. The method also includes determining if the problem still exists, and identifying the suspect component as defective if the problem no longer exists. In addition, the method includes identifying the problem as being caused by another part of the network besides the suspect component, if the problem still exists. An apparatus, system, and computer program are also provided for carrying out the method.

### BACKGROUND OF THE INVENTION

1. Field of the Invention

The present invention relates generally to diagnostics and troubleshooting for optical network equipment, and, more particularly, to diagnostic methods, systems, equipment, and computer programs usable by technicians for identifying defective optical network terminals (ONT) within a passive optical network (PON).

2. Description of the Related Art

There is a growing demand in the industry to find a solution to transmit voice, data, or video from a headend to a subscriber's premises through a fiber optic network all the way into an individual home or business. Such fiber optic networks generally are referred to as fiber-to-the-home (FTTH), fiber-to-the-premises (FTTP), fiber-to-the-business (FTTB), fiber-to-the-node (FTTN), or fiber-to-the-curb (FTTC) networks and the like, depending on the specific application of interest. Such types of networks are also referred to herein generally as “FTTx networks”.

In a FTTx network, such as the one shown in FIG. 1, equipment at a headend or central office couples the FTTx to external services such as a Public Switched Telephone Network (PSTN) or an external network. Signals received from these services are converted into optical signals and are combined onto a single optical fiber at a plurality of wavelengths, with each wavelength defining a channel within the FTTx network.

In a FTTP network, the optical signals are transmitted through the FTTP network to an optical splitter that splits the optical signals and transmits the individual optical signals over a single optical fiber to a subscriber's premises. At the subscriber's premises, the optical signals are converted into electrical signals using an Optical Network Terminal (ONT). The ONT may split the resultant signals into separate services required by the subscriber such as computer networking (data), telephony and video.

In FTTC and FTTN networks, the optical signal is converted to an electrical signal by either an Optical Network Unit (ONU) (FTTC) or a Remote Terminal (RT) (FTTN), before being provided to a subscriber's premises.

A typical FTTx network often includes one or more Optical Line Terminals (OLTs) which each include one or more Passive Optical Network (PON) cards. Such a typical network is illustrated in FIG. 1. Each OLT typically is communicatively coupled to one or more ONT (in the case of a FTTP network), or to one or more Optical Network Units (ONU) (in the case of a FTTC network), via an Optical Distribution Network (ODN). In a FTTP network the ONTs are communicatively coupled to customer premises equipment (CPE) used by end users (e.g., customers or subscribers) of network services. In a FTTC network, the ONU's are communicatively coupled to network terminals (NT), and the NTs are communicatively coupled to CPE. NTs can be, for example, digital subscriber line (DSL) modems, asynchronous DSL (ADSL) modems, very high speed DSL (VDSL) modems, or the like.

In an FTTN network, each OLT typically can be communicatively coupled to one or more RTs. The RTs are communicatively coupled to NTs that are communicatively coupled to CPE.

The network also can comprise an Element Management System (EMS) that can communicate with the OLTs and ONTs. As described above, communication services available in the network may include, for example, a voice service, a data service, and a video service, although in other embodiments they may include other types of services as well, or a fewer number of services.

Generally, a passive optical network (PON) also is made up of fiber optic cabling, passive splitters and couplers that distribute an optical signal through a branched tree topology referred to as an ODN. Each fiber segment is terminated at a connector to make a connection to devices at a customer's premises. A PON's OLT transmits a light signal through the fiber and passive splitters, and distributes the light signal to an ONT, located at the customer premises, where it is converted into an electronic format, for use by customer premises equipment (CPE).

Active optoelectronic equipment often is located at sending (i.e., OLT) and receiving (i.e., ONT) ends of a network, while the ODN often includes passive components. In point-to-multipoint systems, a PON may include one or more of the OLTs located at a central office for servicing groups of downstream ONTs.

When end users experience problems with a network service, they typically attempt to diagnose the problems themselves by checking for faulty connections, evaluating the presence or absence of LED signals on equipment, and/or by consulting equipment manuals and the like. While users sometimes may be able to solve problems on their own without any assistance from the service provider, very often the users cannot do so, and thus they seek troubleshooting assistance from a service provider's customer service entity and/or field technicians. As can be appreciated, such assistance can be costly and inefficient to the service provider, particularly when truck-rolls are involved. Moreover, even in cases where a technician assists in troubleshooting a problem on-site, the technician may not be able to recognize the source of the problem and still may have to contact a network operations center in an attempt to do so.

As with most electronic equipment, an ONT can malfunction. In some cases ONT malfunctions are catastrophic to communications. For example, one common ONT malfunction causes it to send a continuous light signal (modulated or unmodulated) through a shared fiber of an optical distribution network (ODN). This can make it impossible for the OLT to communicate with any of the ONTs on the ODN. Also, in some cases an ONT emits signals that it is eventually going to fail.

A PON transceiver in an OLT is programmed to identify powered-on ONTs cards that are ready to receive commands. This process, also referred to as ranging, can be prevented when an error exists or if the ONT connected on the network is not identified with recognized network identification information, such as a user serial number. The ranging process adjusts the timing for each ONT to compensate for the differential distance from the OLT to the ONT. In addition, once an ONT is ranged, the presence of an error might be undetectable until ranging reoccurs. Ranging typically is initiated when an ONT is rebooted or when another ONT card is added, and therefore does not reoccur often. Thus, only when the ranging process needs to reoccur will such a range blocking type error be detected.

In a PON system, multiple ONTs transmit data to the OLT using a common optical wavelength and shared fiber optic media. Particularly, all the ONT units share an upstream fiber to the PON and are configured to communicate with the PON during a predetermined time slot. As a result of this feature of an PON, another type of ONT malfunction that can occur is when the ONT sends a light signal up to the OLT at inappropriate times while attempting to establish communications, or after having established communications with other ONTs on the ODN. This results in the OLT not being able to communicate with any of the ONTs on the ODN.

An ONT has many failure modes that result in service problems. Because an ONT malfunction may cause problems upstream and downstream of itself, service problems may be caused for one or more customers, thereby making troubleshooting more difficult. For example, a malfunctioning ONT might send a signal up to the OLT with an inappropriate power level. In particular, an ONT might send a power level that is just below the threshold of the PON. This can occur, for instance, when an ONT laser begins to fail. Or, an ONT might send a power level that is just above the threshold of the PON. This problem can also occur, for example, due to a failing laser. Another reason an upstream signal might be above a threshold of the PON is when there is not enough attenuation between the OLT and the ONT because there is not enough fiber optic cabling between the OLT and ONT. In either case, the problem can make it impossible for the OLT to communicate with that ONT on a continuous basis and can cause disruptions in service, and signal sporadic alarms from either the OLT or ONT to a network operator as communications are lost.

In instances where a customer cannot correct the service problem, and the service provider determines that the network problem is localized to the customer, a network technician is usually sent to troubleshoot at the subscriber's premises, and efforts typically are spent troubleshooting problems at the subscriber ONT. In the absence of other indications of ONT failure modes, such as those described earlier, technicians may simply replace an installed customer ONT with a new ONT. Many times, the ONT that was removed is not defective because of a hardware malfunction, but appears to operate improperly due to a network error in provisioning services. Because of the optical to electrical conversion taking place at the ONT it is difficult to determine whether the problem is caused by a network configuration error or an ONT hardware defect. Testing the network with a customer ONT installed in the network may lead a technician to identify the ONT as the defective component when, in fact, the ONT may not be the actual source of the problem. If a substitute ONT, known to be non-defective, is used in place of the customer ONT (that is suspected of being defective), a technician would be able to identify the customer service problem as being related either to the customer ONT or the network.

However, such a technique is hindered because when an ONT ranges with an OLT it must be identified on the network with a unique set of identifiers. Two such identifiers are the ONT serial number and a PLOAM (physical layer operation and maintenance) password. Therefore, if a technician installs a new ONT in place of the customer's ONT, the ONT would be unable to function because the network would not identify the new ONT as the customer's ONT. The only way the new ONT would be functional would be to notify the service provider of the new ONT and its associated serial number and PLOAM password so that the new ONT would be recognized on the network. However, modifying these network settings in turn may modify other network settings that were improperly configured when the customer ONT was installed. As a result the customer ONT would be replaced and identified as defective, even though it may not be defective.

Therefore, it would be useful, to provide an improved method, device, system, and computer program that enable technicians to perform in-situ testing of a network at a subscriber ONT location using a diagnostic ONT, which can be configured with the customer ONT identification information, have equivalent functionality of the customer ONT it replaces, and have a capability to provide troubleshooting access to a technician performing diagnostic testing of the network without effecting network configuration settings. This can minimize or reduce the number of non-defective ONT's returned as defective by technicians.

### SUMMARY OF THE INVENTION

The foregoing and other limitations are overcome by a method for in-situ testing of a communication network, and by an apparatus, system, and computer-readable program, that operate in conjunction with the method.

In one example aspect of the invention, a method is provided for detecting a problem in a communication network that supports at least one communication service communication service. The method includes disconnecting a suspect component from the network, and replacing the suspect component with a diagnostic component configured to have the same network identification information as the suspect component. The method also includes determining if the problem still exists, and identifying the suspect component as defective if the problem no longer exists. In addition, the method includes identifying the problem as being caused by another part of the network besides the suspect component, if the problem still exists.

According to another example aspect of the invention a diagnostic network component is provided, comprising a processor, a memory coupled to the processor, and a console interface coupled to the processor and the memory. The console interface is adapted to receive applied information and forward it to the memory for storage therein. The identification information identifies the diagnostic network apparatus with the same identifier as at least one suspect component of a network.

According to a further example aspect of the invention a diagnostic system is also provided, comprising a diagnostic network component and a diagnostic terminal. The diagnostic network component is comprised of a processor, a memory coupled to the processor, and a console interface coupled to the processor and the memory. The console interface is adapted to receive applied information and forward it to the memory for storage therein, and the information identifies the diagnostic network apparatus with the same identifier as at least one suspect component of a network. The diagnostic terminal is in communication with the diagnostic network component across the console interface, and the identification information is transmitted across the console interface.

### BRIEF DESCRIPTION OF THE DRAWINGS

FIG. 1 represents a conventional FTTx network.

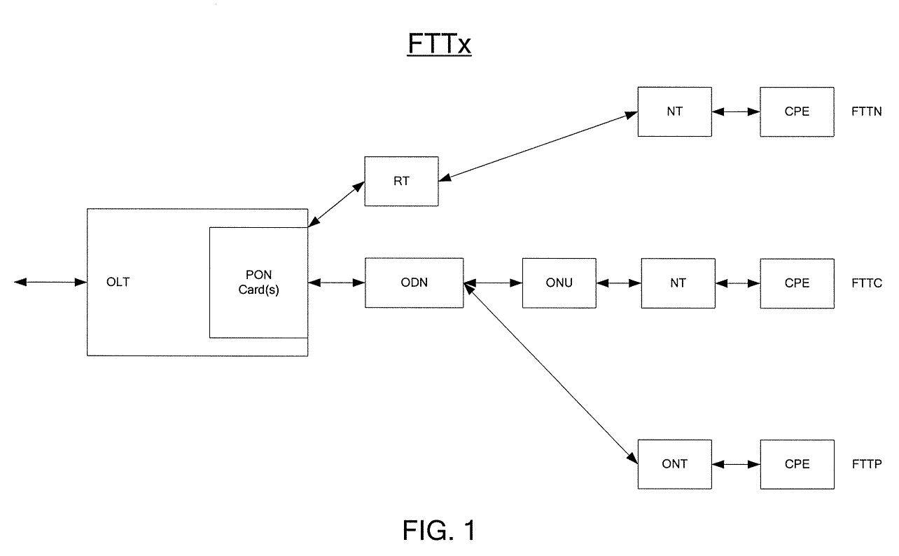

FIG. 2 is a network diagram of an example FTTx network with an EMS suitable for practicing an example embodiment of the present invention.

FIG. 3 is an architecture diagram of an ONT in accordance with an example embodiment of the present invention.

FIG. 4 is a network diagram of an example passive optical network (PON), which may be a more detailed version of the network of FIG. 2.

FIGS. 5 is a flow diagrams that illustrates an existing troubleshooting method.

FIG. 6 is a flow diagram that illustrates a method in accordance with an example embodiment of this invention.

FIG. 7 is a drawing illustrative of a device in accordance with an example embodiment of this invention.

FIG. 8 is a wiring diagram that illustrates an example of a test cable used in accordance with an example embodiment of this invention.

FIG. 9 is a diagram of a system in accordance with an example embodiment of this invention.

FIG. 10 is a diagram of a system in accordance with an example embodiment of this invention

FIG. 11 is an architecture diagram of a data processing system in accordance with an example embodiment of this invention.

Reference numerals that are the same but which appear in different figures represent the same elements, even if those elements are not described with respect to each figure.

### DETAILED DESCRIPTION OF THE INVENTION

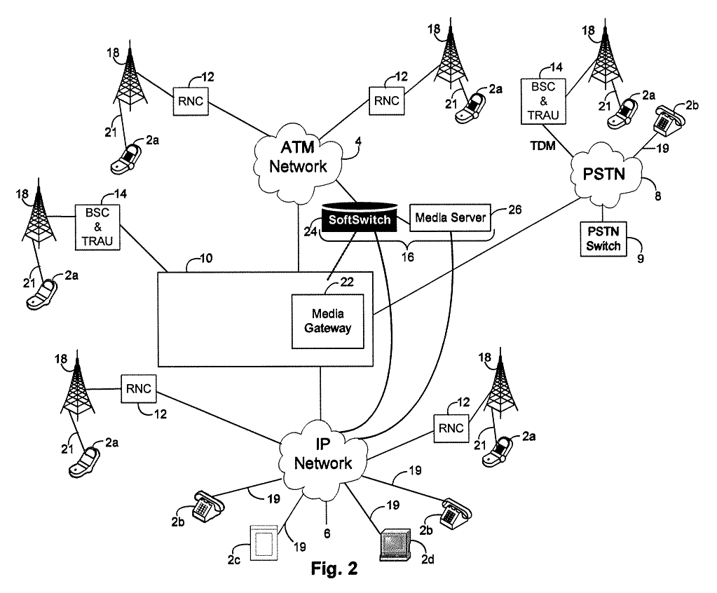

FIG. 2 is a block diagram of a communication system 1 that is suitable for practicing this invention. In the illustrated embodiment, the communication system 1 comprises customer premises equipment such as user communication terminals (devices) 2a, 2b, video devices 2c, computer terminals 2d, and also comprises a plurality of communication networks 4, 6, 8, a gateway 10, and various communication and/or control stations such as, for example, Radio Network Controllers (RNCs) 12, Base station Controllers (BSCs) and Transcoder Rate Adaptor Units (TRAUs), the latter two of which are shown and referred to hereinafter collectively as BSCs/TRAUs 14, base sites or base stations 18, and an Integrated Multimedia Server (IMS) 16. Conventionally, various types of interconnecting mechanisms may be employed for interconnecting the above components as shown in FIG. 2, such as, for example, optical fibers, wires, cables, switches, wireless interfaces, routers, modems, and/or other types of communication equipment, as can be readily appreciated by one skilled in the art, although, for convenience, no such mechanisms are explicitly identified in FIG. 2, besides wireless and wireline interfaces 21 and 19, respectively.

In the illustrated embodiment, the user communication terminals 2a are depicted as cellular radiotelephones that include an antenna for transmitting signals to and receiving signals from a base station 18 responsible for a given geographical cell, over a wireless interface 21.

The RNCs 12 are each communicatively coupled to a neighboring base station 18 and a corresponding network 4 or 6, and are capable of routing calls and messages to and from the user communication terminals 2a when the terminals are making and receiving calls. The RNCs 12 route such calls to the networks 6 and 4. The BSC portion of the BSCs/TRAUs 14 typically controls its neighboring base station 18 and controls the routing of calls and messages between terminals 2a and other components of the system 1 coupled bidirectionally to the respective BSC/TRAU 14, such as, for example, gateway 10 and network 8, and the TRAU portion of the BSCs/TRAUs 14 performs rate adaptation functions such as those defined in, for example, GSM recommendations 04.21 and 08.20 or later versions thereof. The base stations 18 typically have antennas to define their geographical coverage area.

According to the illustrated embodiment, network 8 is the PSTN that routes calls via one or more switches 9, the network 4 operates in accordance with Asynchronous Transfer Mode (ATM) technology, and the network 6 represents the Internet, adhering to TCP/IP protocols, although the present invention should not be construed as being limited for use only with one or more particular types of networks. Also, user communication terminals 2b are depicted as landline telephones, that are bidirectionally coupled to network 6 or 8.

It should be noted that although only the user communication terminals 2a, 2b, 2c, and 2d are shown in FIG. 2, any other suitable types of user communication terminals also may be employed, such as, for example, a portable PC docking node, a web TV, personal digital assistant, handheld personal digital assistant, palmtop computer, cellular radiotelephone, or pager, and the like. Moreover, the total number and variety of user communication terminals that may be included in the overall communication system in general can vary widely, depending on user support requirements, geographic locations, and applicable design/system operating criteria, etc., and are not limited to those depicted in FIG. 2. It should thus be clear that the teaching of this invention is not to be construed as being limited for use with any particular type of communication terminal.

The gateway 10 includes a media gateway 22 that acts as a translation unit between disparate telecommunications networks such as the networks 4, 6, and 8. Typically, media gateways are controlled by a media gateway controller, such as a call agent or a soft switch 24 which provides call control and signaling functionality, and enable multimedia communications across networks over multiple transport protocols, such as by providing conversions between TDM voice and Voice over Internet Protocol (VoIP), radio access networks of a public land network, and Next Generation Core Network technology, etc. Communication between media gateways and soft switches often is achieved by means of protocols such as, for example, MGCP, Megaco or SIP.

Media server 26 is a computer or farm of computers that facilitate the transmission, storage, and reception of information between different points, such as between networks (e.g., network 6) and soft switch 24 coupled thereto. From a hardware standpoint, a server 26 typically includes one or more components, such as one or more microprocessors (not shown in FIG. 2), for performing the arithmetic and/or logical operations required for program execution, and disk storage media, such as one or more disk drives (not shown in FIG. 2) for program and data storage, and a random access memory, for temporary data and program instruction storage. From a software standpoint, a server 26 typically includes server software resident on the disk storage media, which, when executed, directs the server 26 in performing transmission and reception functions. The server software runs on an operating system stored on the disk storage media, such as, for example, UNIX or Windows NT, and the operating system can adhere to TCP/IP protocols. As is well known in the art, server computers can run different operating systems, and can contain different types of server software, each type devoted to a different function, such as handling and managing data/information from a particular source, or transforming data/information from one format into another format. It should thus be clear that the teaching of this invention is not to be construed as being limited for use with any particular type of server computer, and that any other suitable type of device for facilitating the exchange and storage of information may be employed instead.

Although for convenience media server 26 is shown as being a single server, in other example embodiments server 26 may include plural separate servers, wherein each is dedicated to a separate application, such as, for example, a data application, a voice application, and a video application, although in other embodiments the functionality of those servers may be performed by a single server or by a combination of servers.

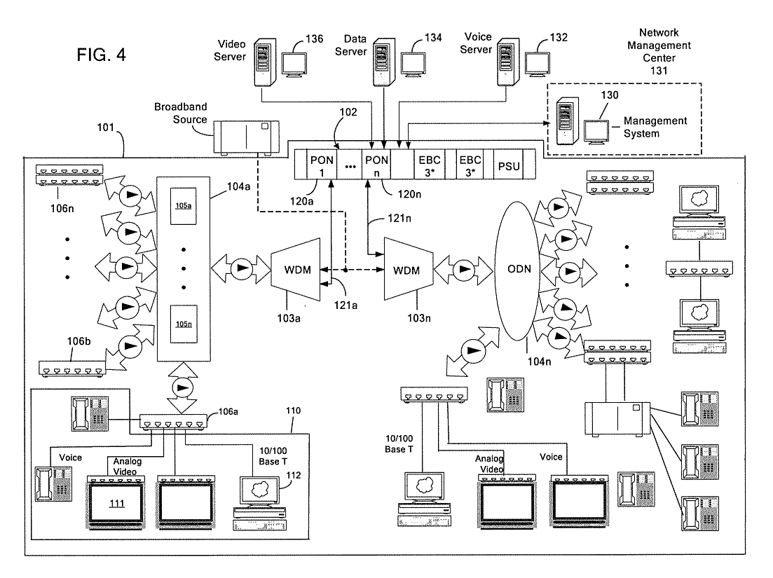

FIG. 4 is a network diagram of an example communication system or network, which may be a more detailed version of one or more of the networks of FIG. 2, such as, for example, network 6.

FIG. 4 further illustrates the OLT 102 managed by an element management system (EMS) 130, that may be managed by a network management center (NMC 131). Since the OLT 102 includes the PON cards 120a-n, each PON card 120a-n is also managed by the EMS 130. As such, a single EMS manages all PON cards within a PON.

A single EMS, however, may manage or otherwise be associated with more than one PON. As such, a single EMS is not limited to managing PON cards within a single PON, but may manage PON cards from several PONs. In other embodiments, more than one EMS can be employed to manage one or more PON cards within a single PON or plural PONs.

FIG. 4 also illustrates plural servers, such as, for example a server 132 that supports voice applications, a server 134 that supports data applications, and a server 136 that supports video applications, although in other embodiments the functionality of those servers may be performed by only a single server or by a combination of servers. In still other example embodiments, the servers 132, 134, 136, and/or Element Management System 130 can be formed by a single server device or a combination of server devices, or no EMS 130 need be provided and the functionality of the EMS 130 can be provided by the servers 132, 134, and 136.

A Passive Optical Network (PON) 101 of the system includes an optical line terminal (OLT) 102, wavelength division multiplexers 103a-n, optical distribution network (ODN) devices 104a-n, ODN device splitters (e.g., 105a-n associated with ODN device 104a), optical network terminals (ONTs) (e.g., 106-n corresponding to ODN device splitters 105a-n), and customer premises equipment (e.g., 110). The OLT 102 includes PON cards 120a-n, each of which provides an optical feed (12la-n) to ODN devices 104a-n. Optical feed 121a, for example, is distributed through corresponding ODN device 104a by separate ODN device splitters 105a-n to respective ONTs 106a-n in order to provide communications to and from customer premises equipment 110.

The PON 101 may be deployed for fiber-to-the-business (FTTB), fiber-to-the-curb (FTTC), and fiber-to-the-home (FTTH) applications, for example. The optical feeds 12la-n in PON 101 may operate at bandwidths such as 155 Mb/sec, 622 Mb/sec, 1.25 Gb/sec, and 2.5 Gb/sec or any other desired bandwidth implementations. The PON 101 may incorporate, for example, ATM communications, broadband services such as Ethernet access and video distribution, Ethernet point-to-multipoint topologies, BPON communications, GPON communications, EPON communications, and native communications of data and time division multiplex (TDM) formats. Customer premises equipment (e.g., 110) which can receive and provide communications in the PON 101 may include standard telephones (e.g., Public Switched Telephone Network (PSTN)), Internet Protocol telephones, Ethernet units, video devices (e.g., 111), computer terminals (e.g., 112), any type of user communication device described above in connection with FIG. 2, digital subscriber line connections, cable modems, wireless access, as well as any other type of customer premise equipment.

PON 101 can include one or more different types of ONTs (e.g., 106a-n). Each ONT 106a-n, for example, communicates with an ODN device 104a through associated ODN device splitters 105a-n. Each ODN device 104a-n in turn communicates with an associated PON card 120a-n through respective wavelength division multiplexers 103a-n. Wavelength division multiplexers 103a-n are optional components which are used when video services are provided. Communications between the ODN devices 104a-n and the OLT 102 occur over a downstream wavelength and an upstream wavelength. The downstream communications from the OLT 102 to the ODN devices 104a-n may be provided at, for example, 622 megabytes per second, which is shared across all ONTs connected to the ODN devices 104a-n. The upstream communications from the ODN devices 104a-n to the PON cards 120a-n may be provided at, for example, 155 megabytes per second, which is shared among all ONTs connected to ODN devices 104a-n, although the invention is not limited to those specific types of downstream and upstream communications only, and may also include the types of example communications referred to above or any other suitable types of communications.

In normal operation, a PON card 120a-n of an OLT 102 ranges an ONT 106a-n to enable communications between the PON card 120a-n and the ONT 106a-n. Once the ONT 106a-n is ranged, the PON card 120a-n can provision the ONT 106a-n to enable or disable a network service to the ONT 106a-n.

The ONT and OLT communicate at the physical layer using PLOAM (physical layer operation and maintenance). At the physical layer the ONT and OLT communicate using user serial numbers and PLOAM passwords. The User Serial Number is a 12 Character HEX String which consists of 4 Characters for Vendor ID and 8 Characters for the unique numbers. In one example ONT, a user serial number may be a series of characters such as such as “TSLS12345678”. Therefore when this example ONT ranges with an OLT, that user serial number will be the identifier for the ONT and the OLT to range (synchronize). During ranging, the OLT also matches the PLOAM Password of the ONT. The PLOAM password, for example, is a 10 character hexidecimal string. An example of a PLOAM password may be “1234567890”.

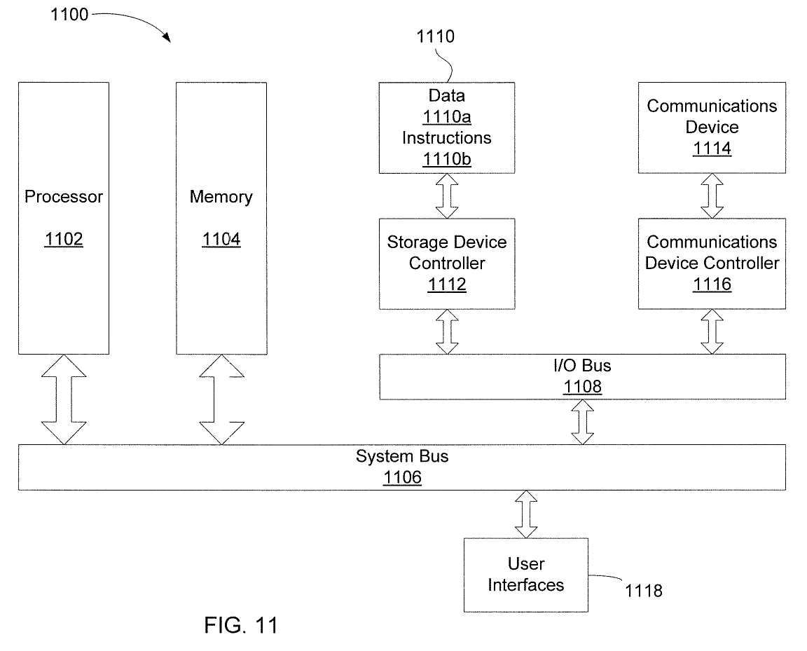

FIG. 11 is an architecture diagram of an example data processing system or device 1100, which, according to an example embodiment of the invention, can form individual ones of the components 110, 130, 102, 104a-n, 106a-n, 132, 134, and 136 of FIG. 4. Data processing system 1100 includes a processor 1102 coupled to a memory 1104 via system bus 1106. Processor 1102 is also coupled to external Input/Output (I/O) devices (not shown) via the system bus 1106 and an I/O bus 1108, and at least one input/output user interface 1118. Processor 1102 may be further coupled to a communications device 1114 via a communications device controller 1116 coupled to the I/O bus 1108. Processor 1102 uses the communications device 1114 to communicate with a network, such as, for example, a network as shown in any of FIGS. 2 and 4, and the device 1114 may have one or more input and output interfaces. Processor 1102 also can include an internal clock (not shown) to keep track of time, periodic time intervals, and the like.

The input/output user interface 1118 may include, for example, at least one of a keyboard, a mouse, a trackball, touch screen, a keypad, and/or any other suitable type of user-operable input device(s), and at least one of a video display, a liquid crystal or other flat panel display, a speaker, a printer, and/or any other suitable type of output device for enabling a user to perceive outputted information.

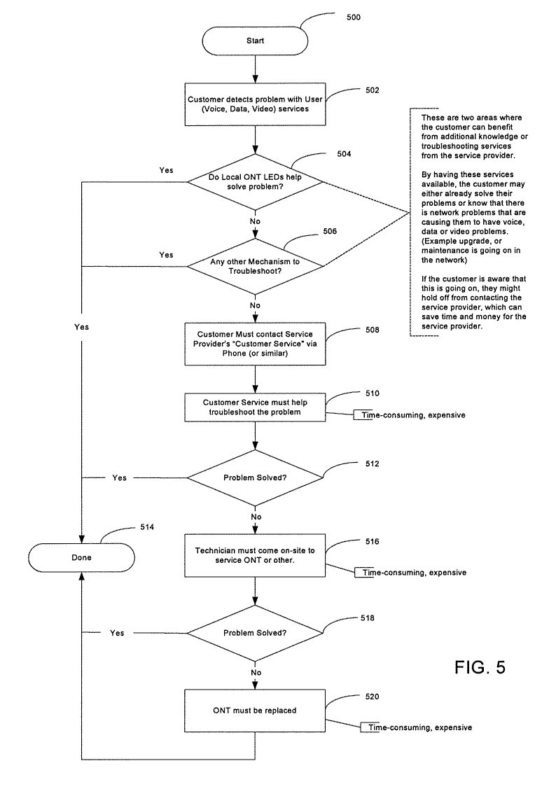

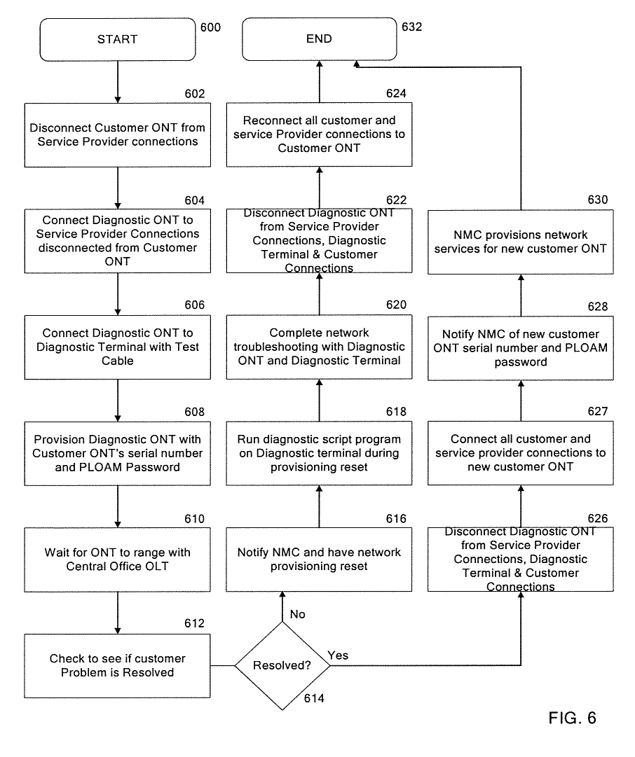

A storage device 1110 having a computer-readable medium is coupled to the processor 1102 via a storage device controller 1112 and the I/O bus 1108 and the system bus 1106. The storage device 1110 is used by the processor 1102 and controller 1112 to store and read/write data 110a, and to store program instructions 1110b used to implement the procedures described below in connection with FIGS. 5 and 6. The storage device 1110 also stores various routines and operating programs (e.g., Microsoft Windows, UNIX/LINUX, or OS/2) that are used by the processor 1102 for controlling the overall operation of the system 1100. At least one of the programs (e.g., Microsoft Winsock) stored in storage device 1110 can adhere to TCP/IP protocols (i.e., includes a TCP/IP stack), for implementing a known method for connecting to the Internet or another network, and may also include web browser software, such as, for example, Microsoft Internet Explorer (IE) and/or Netscape Navigator, for enabling a user of the system 1100 to navigate or otherwise exchange information with the World Wide Web (WWW).

In operation, processor 1102 loads the program instructions 1110b from the storage device 1110 into the memory 1104. Processor 1102 then executes the loaded program instructions 1110b to perform any of the example methods described below, for operating the device 1100.

In the case of at least the OLT 102 (and/or devices 130, 132, 134, 136), the storage device 1110 also stores provisioning information and the like (e.g., Fault, Configuration, Accounting, Performance, Security (FCAPS) information) for the ONTs 106a-n or other devices associated therewith, and maintains records of general conditions of the network 101. Also, in the case of at least the ONTs 106a-n, devices 130, 132, 134, and 136, and/or OLT(s) 102, the instructions 1110b stored in the storage device 1110 also include instructions which, when executed by the processor 1102, enable the detection of alarms and the like, and also enable such detections to be notified via the at least one input/output user interface 1118 and forwarded via communications device 1114 to another destination such as, for example, another OLT 102, ONT 106a-n, ODN 104, and/or device 130, 132, 134, 136. The instructions 1110b also can enable the device 1100 to request, receive and recognize the foregoing received detection notifications, originated from another device such as, e.g., ONTs 106a-n or another device, and to correlate any such notification information with the specific data, video, and/or voice channel(s) or the like for which the detection(s) were made.

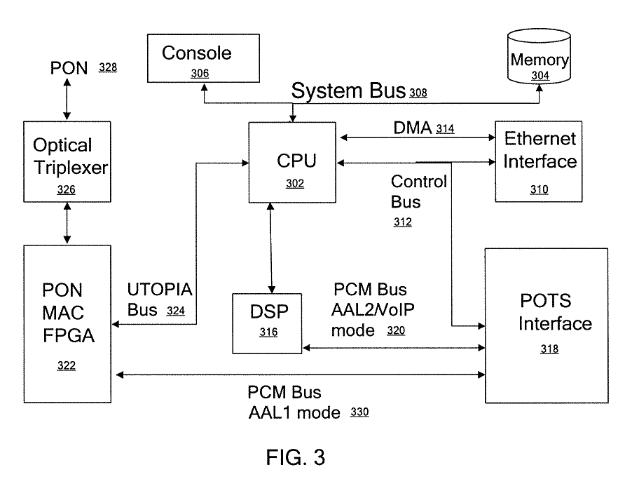

FIG. 3 is an architecture diagram of a diagnostic ONT 300 (also referred to herein as a “Golden ONT”). The architecture of FIG. 3 could also represent a customer ONT deployed in the field. However, as will be described below, console 306 is used differently when ONT 300 is configured as a Golden ONT rather than a customer ONT. ONT 300 includes a processor 302 connected to a memory 304, having a computer-readable medium, and a console interface 306. Memory 304 is a flash memory or another type of memory. The console 306 and memory 304 are connected to the processor 302 over a system bus 308. In operation, processor 302 loads program instructions from the memory 304. Processor 302 then executes the loaded program instructions to perform any of the example methods described below, for operating the diagnostic ONT 300. Processor 302 is also connected to an Ethernet interface 310 via a control bus 312 and a direct memory access (DMA) bus 314. Processor 302 is further connected to a digital signal processor (DSP) 316, which in turn is connected to plain old telephone service (POTS) interface 318 via a PCM bus 320 and the POTS interface 318 is also connected to the processor 302 by the control bus 312. The processor 302 is further connected to a PON media access controller field programmable gate array (MAC FPGA) 322 over a Universal Test and Operations Physical Interface (UTOPIA) bus 324. The PON MAC FPGA 322 is further connected to an optical triplexer 326, which provides ONT connectivity to PON 328. The PON MAC FPGA 322 also is connected with the POTS interface 318 via a PCM bus 330 operating in, for example, AAL1 mode.

In an example embodiment of a Golden ONT such as diagnostic ONT 300, the CPU may be a MIPS-32 RISC processor coupled to a flash memory, such as memory 304. The flash memory may contain a single boot code image (computer program) that executes one of two possible application images (one current image, one backup image) at startup. Each application image may consist of a Linux (version 2.6.8) kernel and a file system containing user applications and data files. In this embodiment there may be a specific monolithic, multi-threaded management user application in the file system that is executed after kernel startup. This application may be responsible for, for example: initializing the triplexer, FPGA and DSP hardware, connecting to the PON via ITU G.983.1, creating management, data and voice flows, provisioning of the video flow within the FPGA, and processing voice, data, and management data packets.

The flash memory of the example embodiment additionally may contain a pseudo-NVRAM storage for basic configuration settings, such as, for example, the ONT's serial number and PLOAM password (described earlier), and also an indicator as to which image is to be booted. The information stored on the flash memory can be changed by communicating with the system bus through the console interface.

The boot code image and the application images stored in the flash memory may provide a computer program interface for local debugging and management of ONT 300, and providing low-level access to memory and devices of ONT 300. The boot code provides access to the NVRAM storage and also trivial file transfer protocol (TFTP) download capability through an ONT Ethernet interface 310 for updating the boot code or either of the application images.

In general, when a customer ONT 300 completes manufacturing and functional testing, the customer ONT 300 is initially programmed with the unique identification information it will use when connected to the network. The transmission of this information to the ONT during manufacturing is made possible by transmitting the information over the console 306 to the system bus 308 and into the memory 304. For example, initial values of an ONT 300 serial number and PLOAM password are stored into an ONTs 300 memory 304. This information stored on a customer ONT is not changed in the field by a technician, nor can it be remotely changed. After manufacturing, a customer ONT 300 is placed into a housing, described below, which completely blocks physical access to the console 306. As a result console 306 of a customer ONT cannot be further utilized after it is manufactured and connected to the network.

However, by making the console 306 partially accessible to access system bus 308 of ONT 300, the Golden ONT can utilize the existing console 306 in new and advantageous ways to carry out the methods described below.

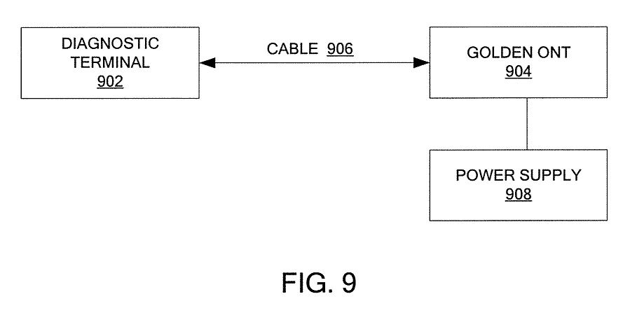

In one example of a diagnostic ONT, the diagnostic ONT 300 is configured as a modified version of a customer ONT, that has, as one of its modifications, the provision of access to a console interface that allows connection of the diagnostic ONT 300 to a diagnostic terminal 902, via a cable 906, described below with reference to FIG. 9. Unlike a customer ONT, such an example diagnostic ONT utilizes most of the same hardware as the customer ONT that it is meant to test, while providing access to the ONT system bus (and therefore the memory storage medium) through a console interface. By ensuring that the diagnostic ONT and the customer ONT share most of the same hardware (model and part number, for example), all of the functionality of the customer ONT can be verified in situ and the OLT can provision all customer services that are provisioned using the customer ONT.

For a diagnostic ONT, access to the ONT system bus is open (as described further below) to allow the diagnostic ONT to be reprogrammed to store the unique network identification information (serial number and PLOAM password) of any customer ONT that the diagnostic ONT seeks to imitate when connected on the network in place of the customer ONT.

In an example embodiment, a management application image provides configuration and management of all PON functions through the PON management channel based on the ITU G983.2 protocol. The management application updates boot code or application images over the management channel from the OLT using the download procedures specified in the ITU G.983.2 protocol standards.

Prior to configuration of any data or voice flows at ONT startup, the ONT ranges with an OLT, as described earlier. The OLT then checks the ONT for versioning information regarding the executing application software image. If the application software image does not match the expected image, the OLT initiates download procedures to load the appropriate image. The management application does not support loading of an application through the local Ethernet port. Therefore, any time an ONT is powered down and rebooted (which includes what occurs during installation) the ranging process occurs. If the proper executing application software image cannot be installed and executed on the ONT, customer service problems result.

Therefore, as described above in an example embodiment, a diagnostic ONT may include a processor executing at least one computer program, stored on a computer-readable storage medium. The computer-readable storage medium also may include storage for data that identifies the ONT on the network. Such data may include an ONT serial number and PLOAM password. A customer ONT is customarily manufactured and programmed with a serial number and PLOAM password before it is installed at a customer premises, and these settings cannot be changed in the field by a technician, although in other embodiments they can be.

### Existing Troubleshooting Procedure

As described in the Background section above, when end users are experiencing problems with a network service, they typically request troubleshooting assistance from a service provider's customer service entity and/or field technicians. An example of a typical manner in which network service problems encountered by a customer are addressed will now be described, with reference to FIG. 5. Proceeding from block 500, subsequently at block 502 it is recognized that a communication problem exists, such as a problem with a network service such as voice, data, and/or video. For example, this recognition may include a user of equipment 110 detecting that a problem exists with one or more of those services.

Depending on the type of customer premises equipment 110 employed, and the services provided by the service provider, it may be possible for the user of the equipment 110 to determine and/or correct the problem without a need to contact the customer service entity of the service provider. For example, the local ONT 106a-n associated with the equipment 110 may have a capability of detecting and/or indicating the existence of a network problem (“Yes” at block 504), such as by emitting a signal via one or more LEDs indicating the detected problem, and the user may be able to correct the problem such as by re-connecting an unintentionally disconnected cable, wire or the like. In another example, an ONT may be able to detect the operating state of ONT services provided to CPE. In one instance the ONT may be able to remotely detect if an Ethernet cable is disconnected from the ONT by sensing that the link is down. As another example, another mechanism may be provided by which the problem can be recognized and/or corrected (“Yes” at block 506). As an example, the user may know the source of the problem, such as by being aware that an upgrade or maintenance procedure is occurring in the network, or by virtue of another reason or mechanism. In either case the user may decide to forego contacting the service provider's customer service entity, which can save time and money for the user and the service provider. If “Yes” at either block 504 or block 506, then the procedure terminates at block 514.

If “No” at both blocks 504 and 506, then the user may elect to contact the service provider's customer service entity (block 508), via for example, telephone or another type of customer premises equipment 110, or any other way of communicating with the customer service entity. The customer service entity then assists in diagnosing, troubleshooting, and correcting the problem, if possible (block 510), which in some cases can be undesirably time consuming and expensive. If the problem then becomes corrected (“Yes” at block 512), then the procedure ends at block 514. Otherwise, if the problem is not solved (“No” at block 512), then a technician may come on-site to attempt to diagnose, troubleshoot, and correct the problem at the applicable ONT 106a-n, equipment 110, or at another network component (block 516), which also can be undesirably time consuming and expensive. If the problem then becomes corrected (“Yes” at block 518), then the procedure ends at block 514. Otherwise, if the problem is not solved (“No” at block 518), the technician may replace the equipment (e.g., ONT 106a-n, equipment 110, and/or another component) deemed to be not functioning correctly (block 520), which also can be undesirably time consuming and expensive. The procedure then ends (block 514).

As already stated, because many replaced ONTs are not defective (block 520), costs incurred in troubleshooting network problems related to provisioning errors and network configuration errors are high due to associated costs of replacement equipment.

In view of the foregoing, it can be appreciated that the above conventional manner of addressing network service problems can be costly and inefficient, and that it would be useful to provide a more efficient, time- and cost-saving procedure for diagnosing and remedying network service problems. The inventors have discovered such a procedure, which will now be described in conjunction with FIGS. 6, wherein a procedure is depicted from the perspective of a technician working at the customer's premises when a customer experiences a network service problem.

### Improved Troubleshooting at Customer Premises by Technician

The following description concern events that occur at blocks 516, 518, and 520 of FIG. 5, and in particular, describes an improvement of the procedure performed at those blocks according to an example embodiment of the invention. In FIG. 6, once it is determined that a technician must be called to the customer's premises to diagnose a service problem (block 516 of FIG. 5), the troubleshooting process begins at block 600 (FIG.6) where the technician is called to the customer ONT. At block 602 the customer ONT is disconnected from the network and removed from service. Removing the customer ONT from service includes disconnecting the ONT at least from the service provider connections. While not shown in FIG. 6, the technician may also disconnect the customer ONT from the customer premises wiring, in order to reconnect the customer premises wiring to a diagnostic ONT (such as ONT 904 of FIG. 9). At block 604 the diagnostic ONT is connected to the same service provider connections that were disconnected from the customer ONT. The diagnostic ONT may then either be connected to some or all of the same customer premises wiring as were disconnected from the customer ONT, or alternatively, other test equipment (e.g., a CPE simulation device, etc.) may be connected to the diagnostic ONT to imitate the functioning of CPE.

For example, in addition to using the diagnostic terminal to monitor performance of the Golden ONT on the network as will be described below, the technician may also use other methods and devices to check customer service problems in conjunction with the Golden ONT while the Golden ONT is installed. For example, while the Golden ONT is connected to the service provider's fiber optic cable, the technician may connect a cable television analyzer to a connector of the Golden ONT to do a frequency scan to check the integrity of the video service provided at the customer premises. To check customer data service a computer may be connected to, for example, an RJ45 port of the Golden ONT to check if the computer acquires an IP address via the Golden ONT. The technician may also use this configuration to run a speed test to ensure that the CPE is able to receive the provisioned data throughput. To check voice telephone service, a technician may connect an analog telephone to, for example, an RJ11 port of the Golden ONT to check if a phone call can be placed, and, if so, validate the voice quality of the call.

Referring again to FIG. 6, at block 606, the technician connects a diagnostic terminal 902 (FIG. 9; ONT 300 of FIG. 3) to the diagnostic ONT 904 (FIG. 9) with a test cable 906 (FIG. 9), to form a diagnostic system 900 (FIG. 9). This connection provides a communication path for the diagnostic terminal to communicate with the diagnostic ONT through the system bus 306 (FIG. 3) while it is operating in situ (in place of the customer ONT). In such an embodiment as shown in FIG. 9 the diagnostic terminal 902 operates as a dumb terminal accessing the diagnostic ONT 904.

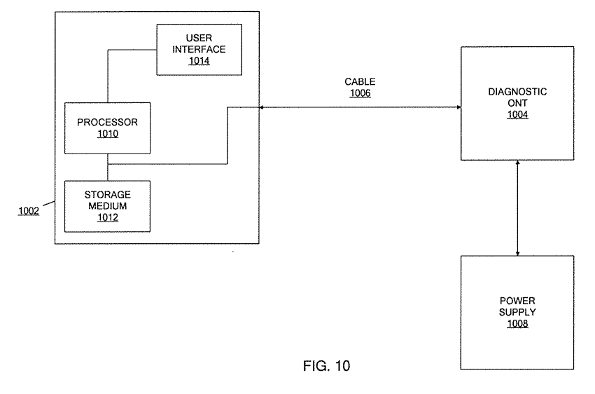

In the example embodiment of a diagnostic system 1000 shown in FIG. 10, the diagnostic terminal 1002 is a computer, such as a portable computer, that includes a processor 1010 executing a computer program stored on a computer-readable storage medium 1012, and a user interface 1014 coupled to the processor 1010. The technician interacts with the diagnostic terminal 1002 by instructing the computer via user interface 1014 (see FIG. 10) to execute various programs and issuing instructions. In one embodiment the diagnostic terminal 1012 executes a terminal emulator program through which the technician interacts with the diagnostic ONT 1004 by issuing instructions. In this embodiment, instructions are sent from the diagnostic terminal 1002 to the diagnostic ONT 1004, where they are processed. Examples of instructions include file transfer instructions, or instructions to alter data stored in the memory storage medium of the diagnostic ONT. Examples of terminal emulators used in an embodiment diagnostic terminal are, without limitation, Microsoft Terminal Emulator, published by Microsoft Corp., or Procomm Plus 4.8, published by Symantec Corp.

The computer programs stored and executed on the diagnostic terminal 1002 can take the form of scripts written specifically for the particular configuration of customer ONT that the diagnostic ONT (i.e., ONT 300, ONT 700, ONT 904, and ONT 1004) is intended to replace. These scripts can be written to analyze data that is collected and/or stored on the diagnostic terminal 1002 as a result of communicating with the diagnostic ONT 1004 across the test cable 1006 that provides the diagnostic terminal 1002 access to the system bus 308 (see FIG. 3) of the diagnostic ONT 1004. In the example embodiments of a diagnostic ONT the console interface 306 is in the form of a serial connection that operates at 11,500 Baud. Such communication allows the diagnostic terminal 1002 and 902, among other things, to collect in situ operating data of the diagnostic ONT without introducing a more obtrusive testing device that may tend to disrupt the signals intended to be analyzed. Such operating data includes, but is not limited to, port status, provisioning status, types of traffic flowing through the diagnostic ONT, the priorities of these traffic flows, self-diagnostic information, RF/optical power level information and ranging status between the diagnostic ONT and the OLT it communicates with.

The diagnostic terminal is also connected to the diagnostic ONT to edit data stored in a computer-readable storage medium of the diagnostic ONT, such as memory 304 of FIG. 3. In one example embodiment this is accomplished by using a terminal emulator program executing on the diagnostic terminal which transmits commands to the diagnostic ONT to change data values stored on the diagnostic ONT. Commands are written in a language or format compatible with the diagnostic ONT. Data modified can include, for example, the serial number and PLOAM (Physical Layer Operations, Administrations and Maintenance) password. As a result, using the diagnostic terminal connected to the diagnostic ONT, a technician can configure the diagnostic ONT to have the same serial number and PLOAM password as those stored in any selected customer ONT. Thus, when one customer ONT is disconnected from the network and a diagnostic ONT having the same serial number and PLOAM password as the customer ONT is connected in the customer ONT's place in a network (and to an OLT) and powered on, the diagnostic ONT appears and functions as a non-defective customer ONT. However, because the diagnostic ONT is a diagnostic testing standard, it is assumed to be trouble-free. Therefore any remaining service problems that may be recognized to still exist after the diagnostic ONT has been set up and installed, are assumed to be attributed to factors other than the customer ONT (e.g., in provisioning or network configuration).

Referring again to FIG. 6, once the diagnostic ONT is fully installed and has the customer ONT's serial number and PLOAM password stored in its memory, at block 610 the diagnostic ONT ranges (synchronizes) with an OLT 102. After the diagnostic ONT ranges, at block 612 the technician verifies if the service problem is now resolved, either by checking provisioned services using CPE (e.g., 110), or by connecting other test equipment to the diagnostic ONT that mimics the CPE and then operating the test equipment to verify if the service problem is resolved. If, after the diagnostic ONT ranges, the service problem is resolved (‘Yes’ at block 614), then the technician identifies the removed customer ONT as defective, disconnects the diagnostic ONT from all connections (block 626), connects all applicable CPE and service provider connections to a new customer ONT (block 627), notifies the NMC 131 (generally by telephone, for example) of the new customer ONT serial number and PLOAM password (block 628), and waits for the NMC 131 and the element management system (EMS) 130 to provision network services for the new customer ONT (block 630). Provisioning includes configuring an ONT using the management interface layer between the ONT and the OLT. This provisioning process can be managed remotely by a NMC 131 using a EMS 130. After provisioning is complete the method then terminates at block 632.

However, if the customer service problem remains unresolved after the Golden ONT ranges (“No” of block 614), the technician identifies the problem as being caused by an error other than due to the removed ONT (the customer ONT), such as a problem with the OLT provisioning services to the customer ONT. While the diagnostic ONT remains installed and connected to the diagnostic terminal, the technician then proceeds to request (generally by telephone, for example) that the NMC, using the element management system thereof, verify the provisioning of services for the customer ONT and to have the network provisioning reset (block 616). Then, while the NMC remotely provisions services, the console port (306 of FIG. 3) on the diagnostic ONT is active, and the field technician can initiate the execution of computer programs stored on a computer readable storage medium of the diagnostic terminal (902 of FIG. 9) to capture operating data (described earlier) during the provisioning (block 618). This information may then be used by the technician to further troubleshoot the network service problem (block 620).

In instances where the technician identifies problems other than with the customer ONT, the diagnostic ONT is removed and disconnected as described above at the completion of troubleshooting (blocks 620 and 622), and the customer ONT that was orginally removed is reconnected to the service provider and CPE connections (block 624). Thereafter, if the problem is resolved no further troubleshooting is necessary. Otherwise if the problem remains unresolved, further network troubleshooting can be performed as deemed appropriate. In either case troubleshooting of the customer ONT ends at block 632.

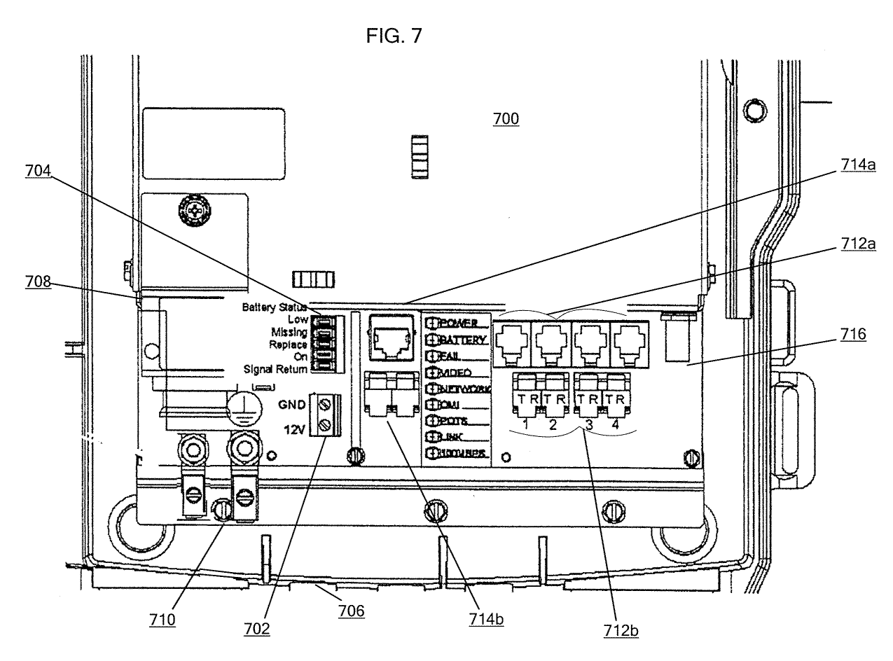

Another example representation of a diagnostic ONT according to at least one embodiment of the invention is shown in FIG. 7. In the example embodiment shown in FIG. 7, diagnostic (Golden) ONT 700 is provided that has at least the same functionality of a customer ONT that it replaces during troubleshooting. In addition, the diagnostic ONT 700 is configured to be portable and carried by a field technician onsite to troubleshoot customer service problems. In one example embodiment the diagnostic ONT is packaged in a portable case with or without a power supply that enables the device to be easily transported, while being protected by the case. The ability to easily transport the diagnostic ONT to the location of the suspect customer ONT allows the technician to easily disconnect the customer ONT from the network and readily position and connect the diagnostic ONT in its place.

The diagnostic ONT 700 also includes a mechanism for powering some or all of its diagnostic devices. The diagnostic ONT, in one example embodiment, is configured to be self-powered (not powered from an electrical outlet) in case there is no electrical power source available in the field to power the ONT during use. A power source may be included within the diagnostic ONT housing or may be external to the diagnostic ONT and be connected via a power transmission line to a connector 702 on the diagnostic ONT, as is shown in the example embodiment in FIG. 7. In an example embodiment the power source used is a DC power source, such as a battery, battery backup unit, or similar device. The diagnostic ONT may also be powered from an AC, DC, or AC/DC power source. In one example embodiment a battery backup device is connected to the diagnostic ONT. The battery backup also has a power cord that can be connected to an alternating current power source (e.g., a power outlet) to power the diagnostic ONT and charge the battery. In this embodiment when the battery backup is not connected to an alternating current power source, or if there is no alternating current flowing through the battery backup device, the ONT can be powered from the battery.

In one example embodiment the ONT 700 has an automatic power saving feature. This feature may be hard wired or pre-programmed, or be hard wired and programmed. In one example embodiment, when powered from a DC power source, such as a battery, the diagnostic ONT 700 operates in a power saving mode, resulting in reduced functionality of the diagnostic ONT and power use. For example, if the ONT 700, when fully powered, is capable of providing telephone, data, and video service, in power saving mode the video service and data service functionality of the diagnostic ONT may be automatically disabled, leaving only the telephone service functional. A customer ONT may behave similarly due to an electrical power outage. However, unlike a customer ONT it replaces for troubleshooting purposes, the diagnostic ONT 700 can include a mechanism to disable the power saving mode, and thereby enable at least one or all of the services disabled by the power saving mode. In one example embodiment of the diagnostic ONT 700, the power saving mode can be disabled during ONT troubleshooting by grounding all power pins of the diagnostic ONT by, for example, connecting all power pins to a grounding resistor incorporated into a connector (not shown) that mates to a mating connector 704 of the diagnostic ONT 700. In other embodiments the power saving feature can be disabled by using a physical switch or button, or a software mechanism such as by a command issued from the diagnostic terminal.

In one example embodiment the diagnostic ONT 700 includes at least one interface each for telephone, television, and data service. These interfaces are used to connect the diagnostic ONT 700 to CPE or other diagnostic devices. In the embodiment of the diagnostic ONT shown in FIG. 7, there are two sets of POTS interfaces 712a and 712b. POTS interfaces 712a and 712b are used to connect customer telephone equipment to the ONT. In one embodiment POTS interfaces 712a contain standard RJ-11 connectors, while interfaces 712b contain insulation displacement (IDC) connectors. The IDC connectors may be used by a technician as an alternate mechanism to connect to the POTS terminals for diagnostic functions. Similarly, CPE using data services can be connected to Ethernet interface 714a, or alternatively, to connector 714b. Connector 714a is, for example, a standard RJ-45 connector or the like. Golden ONT 700 further includes a coaxial connector 716 that supplies video service to CPE. Interfaces 712a, 712b, 714a, 714b, and 716 all enable a technician to connect other diagnostic equipment that imitate the functionality of CPE to verify the quality of provisioned services at the ONT, without requiring the technician to connect the Golden ONT to actual CPE. Moreover, the Golden ONT 700 includes a fiber optic connector for connection to the OLT of a PON.

As mentioned earlier, in one example embodiment of a diagnostic ONT a console interface 706 (306 of FIG. 3) is located on or in the housing of a diagnostic ONT housing 708. The diagnostic ONT 700, 904, 1004 connects to a diagnostic terminal 902, 1002 using a diagnostic cable 906, 1006 connected between the console interface 706 (306 of FIG. 3) and an interface on the diagnostic terminal 902, 1002. In an example embodiment where the console interface 706 (306 of FIG. 3) termination is within the housing of a diagnostic ONT, one end of a diagnostic cable is connected to the diagnostic ONT within the housing 708, and a section of the cable contacting the edge of the housing 708 is rigidly attached to the housing using a cable strain relief 710. The strain relief can be, for example, a cable clamp tightened with a fastener or a cable clip. In this embodiment, the diagnostic cable can be electrically coupled and fixedly attached to the diagnostic ONT 700 using strain relief 710 so that in the field a technician need only make a single connection to the diagnostic terminal from the diagnostic ONT using the diagnostic cable. The console interface 706 may also take the form of a connector at the surface of the diagnostic ONT housing 708. The console interface 706 may also be configured to accept a connector such as, for example, the Molex Series 2295 number 22-01-3037 connector, manufactured by Molex Corp, or the like.

In the example embodiment the diagnostic system shown in FIG. 9, the diagnostic (Golden) ONT 904 (700 of FIG. 7) is connected to a diagnostic terminal 902 via a diagnostic cable 906 that has at least one connector at one end used to connect to the console port of the diagnostic ONT 904 and at least a second connector at the second end to connect to the diagnostic terminal 902. However, it will be appreciated by one of skill in the art in view of this description that other embodiments may have other connections between the diagnostic terminal and the Golden ONT.

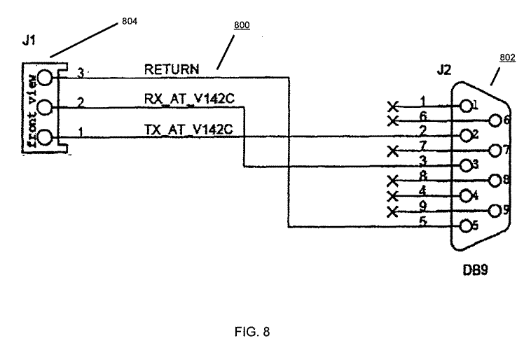

An example embodiment of a diagnostic cable 800 with connectors 802 and 804 is shown in FIG. 8. The cable connector 802 that connects to the diagnostic terminal is, for example, a multipin connector, such as a DB9 connector or the like, that can be used to connect to a serial port (RS-232) located on the diagnostic terminal. One of ordinary skill in the art will appreciate in view of this description that other types of connectors can be used as well. As mentioned above, in the illustrated example, the connector that connects to the Golden ONT console interface 804 is also a multipin connector, such as the Molex Series 2295 number 22-01-3037 connector, manufactured by Molex Corp, or the like.

In one example embodiment of a diagnostic system 900 shown in FIG. 9, diagnostic terminal 902 is connected to the diagnostic ONT 904, configured according to the embodiment of FIG. 3, via diagnostic cable 906, for example cable 800 of FIG. 8. The diagnostic ONT 904 in the illustrated example is powered by an external power source 908, described above. When the diagnostic ONT is powered on (by disabling or turning off any power saving features) the diagnostic terminal can communicate with and utilize all features of the diagnostic ONT. In this embodiment the diagnostic terminal has access to memory 304 through system bus 308. As already mentioned above, using this embodiment of the system, a technician can input instructions into the diagnostic terminal to communicate with the diagnostic ONT. Examples of data stored on the diagnostic ONT and modified include a serial number and PLOAM password.

In the foregoing description, the invention is described with reference to specific example embodiments thereof. The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the present invention.

Software or computer program embodiments of the present invention may be provided as a computer program product, or software, that may include an article of manufacture on a machine accessible or machine readable medium (memory) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “machine accessible medium,” “machine readable medium,” or “computer readable medium” used herein shall include any medium that is capable of storing, encoding, or transmitting a sequence of instructions for execution by the machine or computer and that cause the machine or computer to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other embodiments, functions performed by software can instead be performed by hardcoded modules, and thus the invention is not limited only for use with stored software programs.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

It should be apparent to one of skill in the art in view of this description that the invention is not limited to use only with respect to detecting a defective ONT on a PON network, but also can be used to detect problems that may be occurring with other types of network components on other types of communication networks, where the component is uniquely identified by at least one network identifier. One example of one such network component that is identified by a unique network identifier is a cable modem identified by a unique media access control (MAC) address operating on a cable network. This example is not meant to be limiting, but only to illustrate that other similar communication components and networks that may suffer problems may lend themselves to similar solutions as those described above with respect to ONT's.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive.

What is claimed is:

1. A method of detecting a problem in a communication network that supports at least one communication service, the method comprising:
disconnecting a suspect component from the network where the suspect component has network identification information;
replacing the suspect component with a diagnostic component configured to have the same network identification information as the suspect component;
determining if the problem still exists;
identifying the suspect component as defective if the problem no longer exists; and
identifying the problem as being caused by another part of the network besides the suspect component, if the problem still exists.

2. A method as set forth in claim 1, wherein the at least one communication service includes at least one of a voice service, a data service, and a video service.

3. A method as set forth in claim 1, wherein the suspect component is a customer Optical Network Terminal (ONT) and the diagnostic component is a diagnostic ONT having the same network identification information as the customer ONT.

4. A method as set forth in claim 1, wherein the replacing includes:
connecting the diagnostic component in the network in place of the suspect component; and
configuring the diagnostic component to have the same network identification information as the suspect component.

5. A method as set forth in claim 4, wherein the configuring includes
connecting a diagnostic terminal to a console interface of the diagnostic component;
issuing instructions from the diagnostic terminal to the diagnostic component, wherein the instructions contain the same network identification information as the suspect component; and
storing the network identification information.

6. A method as set forth in claim 5, wherein the network identification information includes a serial number and a physical layer operation and maintenance (PLOAM) password.

7. A method as set forth in claim 6, further comprising:
synchronizing the diagnostic component with another component of the network that recognizes the same network identification information as the suspect component; and
configuring the diagnostic component to provide network services.

8. A diagnostic network component, comprising:
a processor;
a memory coupled to the processor; and
a console interface coupled to the processor and the memory, the console interface adapted to receive applied information and forward it to the memory for storage therein,
wherein the applied information identifies the diagnostic network apparatus with the same information as at least one suspect component of a network.

9. The apparatus of claim 8, further comprising a power supply interface.

10. The apparatus of claim 9, further comprising:
a network interface to connect the diagnostic network component to a network; and
at least one service interface for connecting the diagnostic network component to customer equipment.

11. The apparatus of claim 10, wherein a service interface includes
a telephone service interface;
a television service interface; and
a data service interface.

12. The apparatus of claim 8, wherein the diagnostic network component is configured to selectively operate in a reduced low power mode.

13. The apparatus of claim 12, wherein the reduced low power mode can be disabled.

14. The apparatus of claim 8, wherein the console interface is a serial interface.

15. The apparatus of claim 8, wherein the diagnostic network component is portable.

16. The apparatus of claim 8, wherein the diagnostic network component functions as an optical network terminal (ONT) in a passive optical network (PON).

17. The apparatus of claim 8, wherein the applied information includes a serial number and a physical layer operation and maintenance (PLOAM) password.

18. A diagnostic system comprising:
a diagnostic network component, comprised of:
a processor,
a memory coupled to the processor,
a console interface coupled to the processor and the memory,
the console interface adapted to receive applied information and forward it to the memory for storage therein,
wherein the applied information identifies the diagnostic network apparatus with the same identifier as at least one suspect component of a network; and
a diagnostic terminal in communication with the diagnostic network component via the console interface, wherein the applied information is transmitted to the diagnostic network component from the diagnostic terminal across the console interface.

19. The system of claim 18, wherein the diagnostic network component is configured to selectively operate in a reduced low power mode.

20. The system of claim 19, wherein the reduced low power mode can be disabled.

21. The system of claim 18, wherein the console interface is a serial interface.
